(19) United States
(12) Patent Application Publication
(10) Pub. No.: US 2005/0264399 A1
(43) Pub. Date: Dec. 1, 2005

(54) Remote control system and method

(75) Inventors: Kentaro Teshima, Kariya-city (JP); Kazuhiro Nakashima, Kariya-city (JP); Takeshi Kumazaki, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/098,476

(22) Filed: Apr. 5, 2005

(30) Foreign Application Priority Data
May 28, 2004 (JP) 2004-159599

(51) Int. Cl. H04B 1/00; G08C 19/00

(52) U.S. Cl. 340/5.62; 340/5.72

(57) ABSTRACT

In an electronic key system for vehicles, a remote controller transmits a response signal including identification information in response to a request signal from a vehicle-mounted transmitter. A control unit enables door unlocking as a smart key function when identification information of the response signal agrees to pre-stored information. The control unit checks whether a plurality of switches are operated in a predetermined manner by a user. The control unit reverses the setting of the smart key function between ON and OFF, when the check result is YES. The switches are existing ones provided for vehicle door control. Preferably, the operations of the switches in the predetermined manner are attained after the door is unlocked by the remote controller.

### CROSS REFERENCE TO RELATED APPLICATION

This application is based on and incorporates herein by reference Japanese Patent Application No. 2004-159599 filed on May 28, 2004.

### FIELD OF THE INVENTION

The present invention relates to a remote control system and method having a smart key function, which controls a vehicle-mounted device for instance.

### BACKGROUND OF THE INVENTION

As a remote control system for a vehicle, a smart key system is conventionally used to remotely control vehicle-mounted devices. In this system, a vehicle-mounted transmitter transmits a request signal outward periodically so that a portable remote controller (electronic key) in a predetermined area may receive it. The controller transmits a response signal in return so that a vehicle-mounted receiver receives it.

An electronic control unit in a vehicle compares a code included in the response signal with a code pre-stored in the control unit and, when the codes agree, controls a vehicle-mounted device. The vehicle-mounted device control includes, for instance, locking/unlocking of vehicle doors or starting a vehicle engine. It is also possible to automatically lock vehicle doors when the vehicle-mounted receiver does not receive the response signal from the remote controller any more.

It is desired in this smart key system to switch over the smart key function to be operative (ON) or inoperative (OFF). This switching function is required to meet user's preferences or to protect patients who use cardiac pace makers. For this reason, as proposed in U.S. Pat. No. 6,670,883 B1 (JP 2001-98810A) or JP 2000-170420A, a remote controller is provided with a switch, which when activated by a user switches a smart key function to be inoperative by stopping transmission of a request signal form a vehicle-mounted transmitter.

This switch will however add costs. It may erroneously stop the smart key function when unintentionally activated for some reason, causing the user to feel failure of the controller.

### SUMMARY OF THE INVENTION

It is therefore an object of the present invention to provide a remote control system and method, which is capable of switching a remote controller between ON and OFF without a switch specific to the smart key function switching.

According to the present invention, a remote control system has a smart key function, in which a transmitter periodically transmits a request signal and a control unit automatically controls a device in response to a response signal generated from a remote controller in response to the request signal. The control unit checks whether a switch connected to the device is operated in a predetermined manner in connection with an operation of the device by a user. The control unit then reverses a mode of operation of the transmitter between stopping a periodic transmission of the request signal to cancel the smart key function and attaining the same to perform the smart key function when the switch is operated in the predetermined manner.

Preferably the device is a vehicle door, and the switch includes a door switch operable with opening and closing the door and a door lock position switch operable with locking and unlocking of the door. The control unit starts its checking operation only after the door is unlocked so that the door is operated by the user from either an inside or an outside of the vehicle. The control unit indicates a reversal of the mode of operation to the stopping and the attaining of the periodic transmission of the request signal of the transmitter in different modes.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a remote control system according to an embodiment of the present invention; and

FIG. 2 is a flow diagram showing processing of switching over a smart key function between ON and OFF.

### DETAILED DESCRIPTION OF THE PREFERRED EMBODIMENT

A remote control system according to the present invention will be described in detail with reference to an embodiment. This system is an electronic key system, which includes both a smart key system and a remote keyless entry system for a vehicle. The smart key system is for automatically unlocking doors of a vehicle when a carrying an authorized remote controller enters a predetermined radio communication area around the vehicle. The remote keyless entry system (RKE) is for remotely controlling locking and unlocking of doors by manual operations of an authorized remote controller by a user.

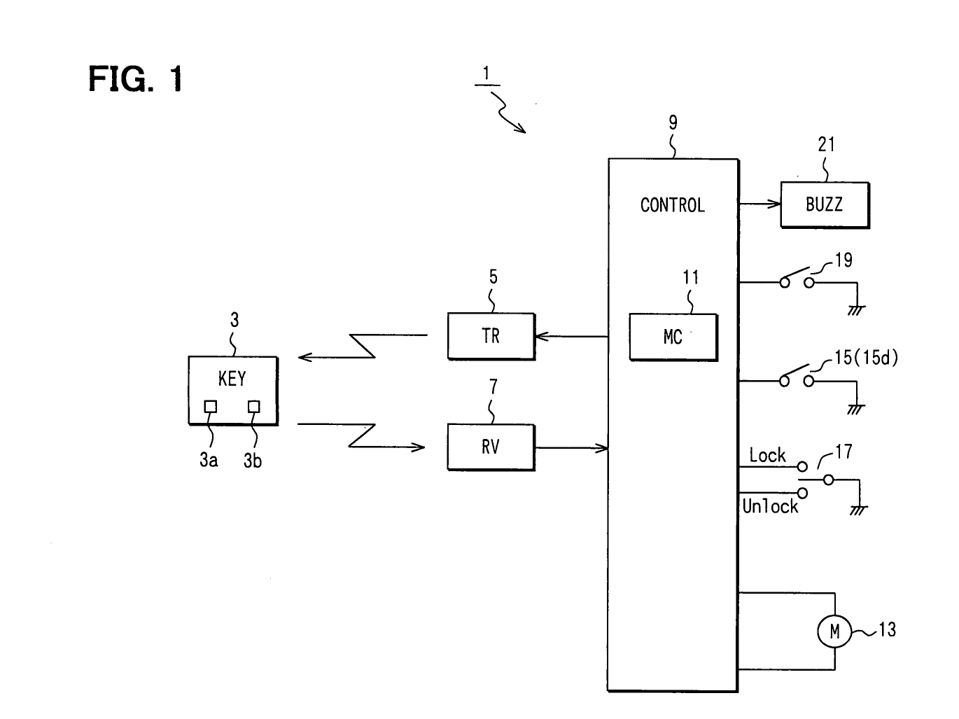

As shown in FIG. 1, an electronic key system 1 includes a portable remote controller 3 carried by a user of a vehicle as an electronic key, a radio transmitter 5 mounted in the vehicle, a radio receiver 7 mounted in the vehicle, and an electronic control unit 9 mounted in the vehicle and connected to the transmitter 5 and the receiver 7.

The transmitter 5 periodically transmits a request signal into a radio communication area around the vehicle, and the receiver 7 receives a response signal transmitted from the remote controller 3 in response to each request signal. The control unit 9 includes a microcomputer 11, which controls operation of the control unit 9.

The control unit 9 is connected to a motor 13, a door switch 15, a door lock position switch 17, a door contact sensor 19 and a buzzer 21. The motor 13 is for locking and unlocking the vehicle door. The door switch 15 is for detecting open/close condition of the door. The door lock position switch 17 is for being operated by the user to a door locking position and a door unlocking position when the door is to be locked and unlocked, respectively. The door contact sensor 19 is for detecting a contact of the user with the door (e.g., door knob).

The motor 13 and the door switch 15 are installed in each door. The door lock position switch 17 is installed in the inside part of the door next to a driver's seat. The door contact sensor 19 is installed in the outside part of the door next to the driver's seat.

The functions of the smart key system and the RKE are known. The general operations of those systems will be described in connection with the control unit 9.

(1) RKE Function

(1-1) The remote controller 3 transmits a RKE signal when a vehicle user presses a door locking button 3a or a door unlocking button 3b. The buttons 3a and 3b include switches, which are turned on when pressed. The RKE signal includes RKE identification information specific to each vehicle. The RKE signal also includes door locking instruction information and door unlocking instruction information, when the door locking button 3a and the door unlocking button 3b are pressed, respectively.
(1-2) The control unit 9 checks whether the RKE identification information in the RKE signal agrees with a pre-stored RKE identification information, when the receiver 7 receives the RKE signal from the remote controller 3. This pre-stored information is specific to the vehicle, in which the control unit 9 is mounted.

The control unit 9 drives the motor 13 to lock or unlock all doors of the vehicle based on the included door control information (lock or unlock), when both RKE identification information agree, that is, the remote controller 3 is confirmed as authorized one. The door control apparatus 9 also drives the buzzer 21 at this moment to inform the user that the doors are locked or unlocked by way of the RKE function.

(2) Smart Key Function

(2-1) The control unit 9 periodically drives the transmitter 5 to transmit a transmission request signal.
(2-2) The remote controller 3 transmits a response signal in return, when the user comes in the predetermined communication area of the transmitter 5 and the remote controller 3 receives the request signal. This response signal includes smart identification information specific to each vehicle.
(2-3) The control unit 9 checks whether the smart identification information in the RKE signal agrees with a pre-stored smart identification information, when the receiver 7 receives the return signal from the remote controller 3. This pre-stored information is specific to the vehicle, in which the control unit 9 is mounted. This checking is attained under the condition that the vehicle is held parked with its all doors being closed and locked.

The control unit 9 permits unlocking of the doors when both smart identification information agree. The control unit 9 drives the motor 13 to unlock all the doors when the door contact sensor 19 detects use's contact with the door knob under the door unlocking is permitted.

Although not related to the remote controller 3, the control unit 9 also detects that the door lock position switch 17 is operated to the door locking position, and drive the motor 13 to lock all the doors. The control unit 9 drives the motor 13 to unlock all the doors when the door lock position switch is operated to the door unlocking position.

The control unit 9 further detects whether each door is held open or closed based on the signal from each door switch 15. This door switch 15 is constructed to turn on when the door is open. Thus, the door switch 15 forms a current supply path to activate a warning light or a compartment light in the vehicle to indicate the door open condition.

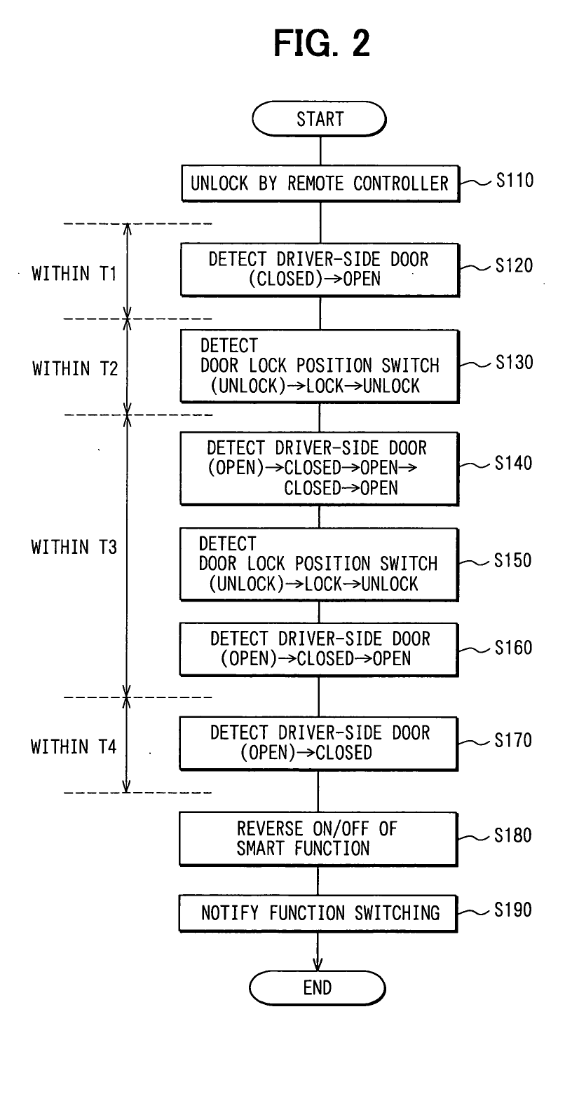

Next, the switching on and off of the smart key function of the electronic key system 1 will be described with reference to FIG. 2. Here, in the ON condition of the smart key function, the control unit 9 (particularly microcomputer 11) performs the above operations (2-1) and (2-3). In this instance, the transmitter 5 operates in the first mode to periodically transmit the request signal. In the OFF condition of the smart key function, the control unit 9 disables the transmitter 5 to transmit the request signal and stops performing the above operations (2-1) and (2-3). In this instance, the transmitter 5 operates in the second mode not to transmit the request signal.

In this embodiment, the control unit 9, particularly the microcomputer 11, is programmed to switch on the smart key function when the predetermined following conditions are confirmed at steps (S) 110 to 170 in the predetermined order.
(a: S110) The unlocking button 3b of the remote controller 3 is operated under the condition that the vehicle is parked and its all doors are held closed.

The operation of the unlocking button 3b is detected based on the operation instruction information included in the RKE signal transmitted from the remote controller 3. In this case, the controller 9 drives the motor 13 to unlock all the doors. In cooperation of this unlocking by the motor 13, the door lock position switch 17 of the driver-side door next to the driver's seat is driven to the unlocking position.
(b: S120) Within a time period T1 (for instance 5 seconds) from the door unlocking (a), the driver-side door is opened from the closed condition.

The opening of the driver-side door is detected based on the door switch 15 (particularly switch 15d of the driver-side door) changing from OFF to ON.
(c: S130) Within a time period T2 (for instance 5 seconds) from the driver-side door opening (b), the door lock position switch 17 of the driver-side door is changed from the unlocking position to the locking position and then changed again to the unlocking position.
(d: S140-S160) Within a time period T3 (for instance 40 seconds) from the door lock position switch change (c), the driver-side door is closed from the open condition and then opened, closed and opened in sequence. That is, the door switch 15d of the driver-side door is changed from ON to OFF, ON, OFF and ON in sequence. Subsequently, the door lock position switch 17 is operated to the unlocking position, the locking position and the unlocking position in sequence. After this sequence, the driver-side door is closed from the open condition and then opened again. That is, the door switch 15d of the driver-side door is changed from ON to OFF and then ON again.
(e: S170) Finally, within a time period T4 (for instance 5 seconds) from the above sequential operation of the driver-side door, the driver-side door is closed from the open condition. That is, the door switch 15d of the driver-side door is changed to OFF from ON.

The control unit 9 then reverses its internal setting (ON or OFF) of the smart key function at S180, after confirming that the above requirements (a)-(e) are satisfied in order. The electronic key system 1 is operable in the first mode to perform the operations (2-1) and (2-3) when the smart key function is set to ON. Thus, the transmitter 5 periodically transmits the request signal. It is however operable in the second mode not to perform the operations (2-1) and (2-3) when the smart key function is set to OFF. Thus, the transmitter 5 does not transmit the request signal.

The control unit 9 drives the buzzer 21 as an indicator to indicate the user at step S190 that ON/OFF of the smart key function has been reversed. The buzzer 21 may be driven in a different way so that the user may recognize which way the function is changed. For instance, the buzzer 21 may be driven once (first indication mode) when the smart key function is turned on, and twice in succession (second indication mode) when the smart key function is turned off.

As described above, the ON/OFF of the smart key function of the electronic key system 1 can be set by the user's predetermined operations which are detected by a plurality of switches 3b, 15d and 17. Those switches are originally for the conventional door control, and not additional nor specific to the setting of the specific smart key function. Further, the ON/OFF of the smart key function can be changed only when the switches are operated in the predetermined sequence or manner (a) to (e). Therefore, the user will not unintentionally sets the smart key function to OFF and will not misunderstand that the electronic key system 1 is inoperative or in failure.

The setting of the smart key function may be enabled and disabled when the user attains the switches in the first predetermined manner and in the second predetermined manner different from each other, respectively. In this embodiment, however, the smart key function setting is reversed each time when the switches are operated in the above single sequence (a) to (e). Therefore, the user needs to learn only one operation sequence (rule) for reversing the ON/OFF setting of the smart key function, and can easily set the ON/OFF of the smart key function without learning many operation sequences.

The unlocking button 3b of the remote controller 3 and the driver-side door (driver-side door switch 15d) can be attained either inside or outside the vehicle. The door lock position switch 17 of the driver-side door can be operated either inside or outside as long as the driver-side door is open. The above sequence of required conditions (a) to (e) are set to be attained only under the condition that the door lock position switch 17 is operated while the driver-side door is open. Therefore switching the ON/OFF setting of the smart key function can be attained either inside of outside the vehicle.

The above embodiment of the electronic key system 1 may be modified in various ways with respect to its smart key function.

For instance, the door unlocking may be enabled immediately without confirming that the user touches the door knob, when the control unit 9 confirms that the smart identification information included in the smart signal transmitted from the remote controller 3 agrees to the pre-stored one.

The smart key function may also include automatic door locking control, in which all the doors are automatically locked by the motor 13, when it becomes impossible for the receiver 7 to receive the smart signal from the remote controller 3 under the vehicle parking condition because of leaving of the user from the vehicle. The smart key function may further include permission of engine starting.

In addition, the existing switches used and the sequence of operation for changing the ON/OFF setting of the smart key function may are not limitative.

The electronic key system 1 may be adapted to various objects other than vehicles. Such objects may include houses and the like.

1. A remote control system for a device, the system comprising:
a transmitter, mounted in a vehicle, for transmitting a request signal in a predetermined area;
a receiver, mounted in the vehicle, for receiving a response signal generated from a remote controller of a user entering the predetermined area in response to the request signal;
a control unit, mounted in the vehicle, for controlling the device of the vehicle in response to the response signal; and
a switch connected to the device and operable with the device,
wherein the control unit includes
means for checking whether the switch is operated in a predetermined manner, and
means for switching over a setting of the transmitter between a first operation mode for a transmission of the request signal and a second operation mode for a non-transmission of the request signal, when the switch is operated in the predetermined manner.

2. The remote control system according to claim 1, wherein the control unit includes means for reversing the setting of the transmitter each time the switch is operated in the predetermined manner.

3. The remote control system according to claim 1, wherein the switch is operable in the predetermined manner by the user from both inside and outside of the vehicle.

4. The remote control system according to claim 1, further comprising:
an indicator device, mounted in the vehicle, for indicating switching of the setting of the transmitter to the first operation mode and the second operation mode in a first indication mode and a second indication mode different from each other, respectively.

5. The remote control system according to claim 1, wherein the switch is mounted in a vehicle door.

6. The remote control system according to claim 5, wherein the switch includes a door switch for detecting opening and closing of the door.

7. The remote control system according to claim 5, wherein the switch includes a door lock position switch for detecting locking and unlocking of the door.

8. The remote control system according to claim 5, wherein the door is a driver-side door of the vehicle.

9. The remote control system according to claim 1, wherein the device is for locking and unlocking a vehicle door and the switch includes both of a door switch and a door lock position switch of a driver-side door, the door switch being operable in correspondence with opening and closing of the driver-side door and the door lock position switch being operable with locking and unlocking of the driver-side door.

10. The remote control system according to claim 1, wherein the predetermined manner includes an operation of the switch within a predetermined time.

11. A method of controlling a remote control system, in which a transmitter periodically transmits a request signal and a control unit automatically controls a device in response to a response signal generated from a remote controller in response to the request signal, the method comprising steps of:
checking whether a plurality of switches connected to the device is operated in a predetermined manner in connection with an operation of the device by a user; and
reversing a mode of operation of the transmitter between stopping and attaining a periodic transmission of the request signal when the switches are operated in the predetermined manner.

12. The method according to claim 11, wherein the device is a vehicle door, and the switches include a door switch operable with opening and closing the door and a door lock position switch operable with locking and unlocking of the door.

13. The method according to claim 12, wherein the checking starts only after the door is unlocked by the remote controller so that the door is operated by the user from either an inside or an outside of the vehicle.

14. The method according to claim 11, wherein the predetermined manner includes both sequence and time periods of operations of the switches.

15. The method according to claim 11, further comprising:
indicating a reversal of the mode of operation to the stopping and the attaining of the periodic transmission of the request signal of the transmitter in different modes.
